(19) United States
(12) Patent Application Publication
(10) Pub. No.: US 2014/0167912 A1
(43) Pub. Date: Jun. 19, 2014

(54) SYSTEM, METHOD AND APPARATUS FOR PROVIDING SECURITY SYSTEMS INTEGRATED WITH SOLID STATE LIGHTING SYSTEMS

(71) Applicants: David M. Snyder, Cedar Rapids, IA (US); Leslie D. Baych, Cedar Rapids, IA (US); Walter F. Emig, III, Cedar Rapids, IA (US)

(72) Inventors: David M. Snyder, Cedar Rapids, IA (US); Leslie D. Baych, Cedar Rapids, IA (US); Walter F. Emig, III, Cedar Rapids, IA (US)

(21) Appl. No.: 14/145,577

(22) Filed: Dec. 31, 2013

Related U.S. Application Data
(63) Continuation-in-part of application No. 14/108,938, filed on Dec. 17, 2013.
(60) Provisional application No. 61/848,321, filed on Dec. 31, 2012.
(60) Provisional application No. 61/848,322, filed on Dec. 31, 2012.
(60) Provisional application No. 61/848,323, filed on Dec. 31, 2012.
(60) Provisional application No. 61/852,940, filed on Mar. 25, 2013.
(60) Provisional application No. 61/854,633, filed on Apr. 29, 2013.
(60) Provisional application No. 61/854,632, filed on Apr. 29, 2013.
(60) Provisional application No. 61/854,631, filed on Apr. 29, 2013.
(60) Provisional application No. 61/854,630, filed on Apr. 29, 2013.
(60) Provisional application No. 61/854,629, filed on Apr. 29, 2013.
(60) Provisional application No. 61/854,628, filed on Apr. 29, 2013.
(60) Provisional application No. 61/854,627, filed on Apr. 29, 2013.
(60) Provisional application No. 61/854,625, filed on Apr. 29, 2013.
(60) Provisional application No. 61/854,624, filed on Apr. 29, 2013.
(60) Provisional application No. 61/854,623, filed on Apr. 29, 2013.
(60) Provisional application No. 61/854,618, filed on Apr. 29, 2013.
(60) Provisional application No. 61/854,617, filed on Apr. 29, 2013.
(60) Provisional application No. 61/854,616, filed on Apr. 29, 2013.
(60) Provisional application No. 61/854,615, filed on Apr. 29, 2013.
(60) Provisional application No. 61/854,614, filed on Apr. 29, 2013.
(60) Provisional application No. 61/854,613, filed on Apr. 29, 2013.
(60) Provisional application No. 61/854,610, filed on Apr. 29, 2013.
(60) Provisional application No. 61/797,877, filed on Dec. 17, 2012.
(60) Provisional application No. 61/797,873, filed on Dec. 17, 2012.
(60) Provisional application No. 61/797,872, filed on Dec. 17, 2012.
(60) Provisional application No. 61/797,870, filed on Dec. 17, 2012.
(60) Provisional application No. 61/797,869, filed on Dec. 17, 2012.
(60) Provisional application No. 61/797,866, filed on Dec. 17, 2012.
(60) Provisional application No. 61/797,865, filed on Dec. 17, 2012.

(51) Int. Cl. G07C 9/00

(52) U.S. Cl. CPC G07C 9/00174
USPC 340/5.7

(57) ABSTRACT

A security system including a plurality of LED lights with sensors operatively connected to a computer. The computer is also operatively connected to a plurality of other security system components, including, but not limited to, a facial recognition system, a license plate recognition system, an RFID system, a micro-cell which may be operatively connected to an IP telephony network, at least one Bluetooth wireless access point, a Wi-Fi wireless access point, and a communication system, wherein the computer aggregates data and sends commands based on the data.

### CROSS-REFERENCE TO RELATED APPLICATIONS

This application claims priority to U.S. Provisional Application, Ser. No. 61/848,321 filed Dec. 31, 2012.

This application claims priority to U.S. Provisional Application, Ser. No. 61/848,322 filed Dec. 31, 2012.

This application claims priority to U.S. Provisional Application, Ser. No. 61/848,323 filed Dec. 31, 2012.

This application claims priority to U.S. Provisional Application, Ser. No. 61/852,940 filed Mar. 25, 2013.

This application claims priority to U.S. Provisional Application, Ser. No. 61/854,633 filed Apr. 29, 2013.

This application claims priority to U.S. Provisional Application, Ser. No. 61/854,632 filed Apr. 29, 2013.

This application claims priority to U.S. Provisional Application, Ser. No. 61/854,631 filed Apr. 29, 2013.

This application claims priority to U.S. Provisional Application, Ser. No. 61/854,630 filed Apr. 29, 2013.

This application claims priority to U.S. Provisional Application, Ser. No. 61/854,629 filed Apr. 29, 2013.

This application claims priority to U.S. Provisional Application, Ser. No. 61/854,628 filed Apr. 29, 2013.

This application claims priority to U.S. Provisional Application, Ser. No. 61/854,627 filed Apr. 29, 2013.

This application claims priority to U.S. Provisional Application, Ser. No. 61/854,625 filed Apr. 29, 2013.

This application claims priority to U.S. Provisional Application, Ser. No. 61/854,624 filed Apr. 29, 2013.

This application claims priority to U.S. Provisional Application, Ser. No. 61/854,623 filed Apr. 29, 2013.

This application claims priority to U.S. Provisional Application, Ser. No. 61/854,618 filed Apr. 29, 2013.

This application claims priority to U.S. Provisional Application, Ser. No. 61/854,617 filed Apr. 29, 2013.

This application claims priority to U.S. Provisional Application, Ser. No. 61/854,616 filed Apr. 29, 2013.

This application claims priority to U.S. Provisional Application, Ser. No. 61/854,615 filed Apr. 29, 2013.

This application claims priority to U.S. Provisional Application, Ser. No. 61/854,614 filed Apr. 29, 2013.

This application claims priority to U.S. Provisional Application, Ser. No. 61/854,613 filed Apr. 29, 2013.

This application claims priority to U.S. Provisional Application, Ser. No. 61/854,610 filed Apr. 29, 2013.

This application is a Continuation-in-Part of U.S. Ser. No. 14/108,938 filed Dec. 17, 2013.

U.S. Ser. No. 14/108,938 application claims priority to U.S. Provisional Application, Ser. No. 61/797,877 filed Dec. 17, 2012.

U.S. Ser. No. 14/108,938 application claims priority to U.S. Provisional Application, Ser. No. 61/797,873 filed Dec. 17, 2012.

U.S. Ser. No. 14/108,938 application claims priority to U.S. Provisional Application, Ser. No. 61/797,872 filed Dec. 17, 2012.

U.S. Ser. No. 14/108,938 application claims priority to U.S. Provisional Application, Ser. No. 61/797,870 filed Dec. 17, 2012.

U.S. Ser. No. 14/108,938 application claims priority to U.S. Provisional Application, Ser. No. 61/797,869 filed Dec. 17, 2012.

U.S. Ser. No. 14/108,938 application claims priority to U.S. Provisional Application, Ser. No. 61/797,866 filed Dec. 17, 2012.

U.S. Ser. No. 14/108,938 application claims priority to U.S. Provisional Application, Ser. No. 61/797,865 filed Dec. 17, 2012.

The aforementioned applications are herein incorporated in their entirety by reference.

### FIELD OF THE INVENTION

The present invention relates to integrating security into Solid State Lighting Systems at the luminaire, and in the back-end systems and applications, which can be deployed in parking garages, fast food restaurants, malls, schools, universities, businesses, homes, government buildings, campuses of any type, etc.

### BACKGROUND OF THE INVENTION

It is an object of the present invention to use thin film rechargeable batteries as a means to provide functionality.

It is an object of the present invention to use Micro Cells as a means to provide functionality.

It is an object of the present invention to use Picocells as a means to provide functionality.

It is an object of the present invention to use XML as a means to provide functionality.

It is an object of the present invention to use Drupal as a means to provide functionality.

It is an object of the present invention to use Content Management Framework as a means to provide functionality.

It is an object of the present invention to use Wi-Fi as a means to provide functionality.

It is an object of the present invention to use facial recognition as a means to provide functionality.

It is an object of the present invention to use machine vision as a means to provide functionality.

It is an object of the present invention to use magnetic stripe cards as a means to provide functionality.

It is an object of the present invention to use Cryptographic Hashes as a means to provide functionality.

It is an object of the present invention to use encryption as a means to provide functionality.

It is an object of the present invention to use Charge Couple Device (CCD) as a means to provide functionality.

It is an object of the present invention to use cellular networks as a means to provide functionality.

It is an object of the present invention to use Ultra-Wideband as a means to provide functionality.

It is an object of the present invention to use ZigBee as a means to provide functionality.

It is an object of the present invention to use cloud computing as a means to provide functionality.

It is an object of the present invention to use social networks as a means to provide functionality.

It is an object of the present invention to use Software as a Service as a means to provide functionality.

It is an object of the present invention to use Protocol Buffers as a means to provide functionality.

It is an object of the present invention to use wireless mesh networks as a means to provide functionality.

It is an object of the present invention to use Scatternet as a means to provide functionality.

It is an object of the present invention to use wireless ad-hoc networks as a means to provide functionality.

It is an object of the present invention to use button cell batteries as a means to provide functionality.

It is an object of the present invention to use cascading style sheets as a means to provide functionality.

It is an object of the present invention to use mobile ticketing as a means to provide functionality.

It is an object of the present invention to use HTML5 as a means to provide functionality.

It is an object of the present invention to use push technology as a means to provide functionality.

It is an object of the present invention to use social engineering security as a means to provide functionality.

It is an object of the present invention to use fingerprint recognition as a means to provide functionality.

It is an object of the present invention to use speaker (voice) recognition as a means to provide functionality.

It is an object of the present invention to use SMS Barcodes as a means to provide functionality.

It is an object of the present invention to use Near Field Communication as a means to provide functionality.

It is an object of the present invention to use EPCGlobal as a means to provide functionality.

It is an object of the present invention to use barcodes as a means to provide functionality.

It is an object of the present invention to use data transmission as a means to provide functionality.

It is an object of the present invention to use a Global Positioning System as a means to provide functionality.

It is an object of the present invention to use a Hybrid Positioning System as a means to provide functionality.

It is an object of the present invention to use mobile applications as a means to provide functionality.

It is an object of the present invention to use a Universal Mobile Interface as a means to provide functionality.

It is an object of the present invention to use a web service as a means to provide functionality.

It is an object of the present invention to use computers as a means to provide functionality.

It is an object of the present invention to use a port (computer networking) as a means to provide functionality.

It is an object of the present invention to use a computer port (hardware) as a means to provide functionality.

It is an object of the present invention to use a hash chain as a means to provide functionality.

It is an object of the present invention to use Power Over Ethernet as a means to provide functionality.

It is an object of the present invention to use IP Addresses as a means to provide functionality.

It is an object of the present invention to use home automation as a means to provide functionality.

It is an object of the present invention to use a smart grid as a means to provide functionality.

It is an object of the present invention to use a user interface as a means to provide functionality.

It is an object of the present invention to use Square (application) as a means to provide functionality.

It is an object of the present invention to use the PCI Data Security Standard as a means to provide functionality.

It is an object of the present invention to use Transport Layer Security (TLS) and (SSL) as a means to provide functionality.

It is an object of the present invention to use strong cryptography as a means to provide functionality.

It is an object of the present invention to use a smart card (access card) as a means to provide functionality.

It is an object of the present invention to use access control as a means to provide functionality.

### SUMMARY OF THE INVENTION

The present invention relates to integrating security into, and in conjunction with Solid State Lighting Systems at the luminaire, other equipment, and in the back-end systems and related applications, which can be deployed in parking garages, fast food restaurants, malls, schools, universities, businesses, homes, government buildings, campuses of any type, etc.

LED Lights within the present invention can be used as the integration platform for an Identify Friend or Foe (IFF) electronic surveillance system. Cell phones, Bluetooth Low Energy transponders, and Wi-Fi signals can all be part of a comprehensive system to electronically detect, locate, and monitor the movement of individuals, vehicles, and assets in corporate offices, factories, warehouses, college campuses, automobile dealer lots, parking garages, etc. Femtocells (aka Microcells) (miniature cellphone towers), Bluetooth transceivers, and Wi-Fi routers can be co-located within LED Lights to create an extensible combined power/data network. This combined network will be capable of delivering power to LED lights over Ethernet cables, and also transmit/receive data over the same Ethernet cables used power the lights.

### BRIEF DESCRIPTION OF THE DRAWINGS

FIG. 1 is an illustration of the present invention.

FIG. 2 is an illustration of the transponder configured for use within the present invention.

### DETAILED DESCRIPTION OF THE PREFERRED EMBODIMENTS

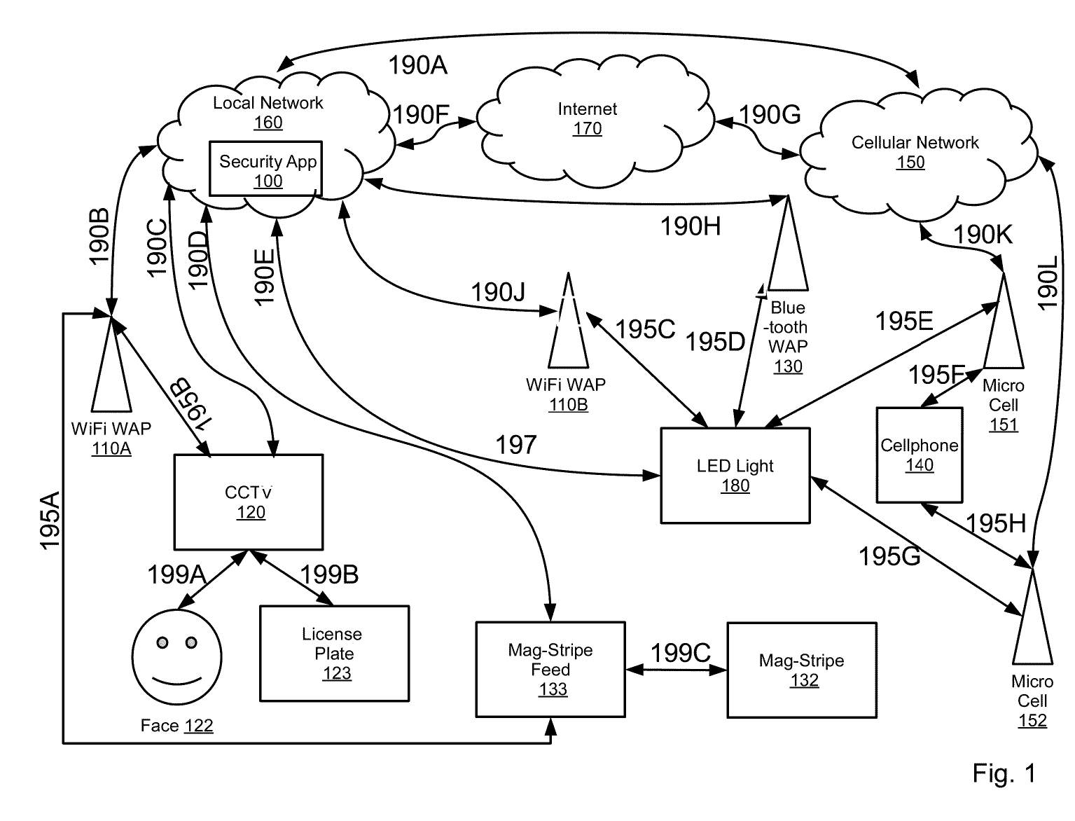

FIG. 1 is an illustration of the present invention, which consists of elements described below.

Security app 100 is a software application that includes all the computer software to perform all the tasks associated with the present invention. Security app 100 operates on a programmable machine designed to sequentially and automatically carry out a sequence of arithmetic or logical operations. The programmable machine consists of some form of memory for data storage, at least one element that carries out arithmetic and logic operations, and a sequencing and control element that can change the order of operations based on the information that is stored.

Alternatively, security app 100 may partially run on firmware, or be embedded in hardware.

One task that security app 100 may be running is an optional computer application for automatically identifying or verifying a person from a digital image or a video frame from a video source, which is commonly known as facial recognition. Security app 100 would analyze an image of selected facial features and compare them to an image and a facial features database. Security app 100 could also be used for other biometrics, such as, but not limited to, fingerprint, or voice, or eye iris recognition systems.

Another task security app 100 may be running is an optional Automatic Number Plate Recognition (ANPR) system, which is a surveillance method that uses optical character recognition (OCR) to decode the alphanumerics on vehicle license plates, which are also known as vehicle registration plates.

The software required to run an ANPR system uses 1) a series of image manipulation processing techniques to detect, normalize and enhance the image of the license plate, and 2) an optical character recognition (OCR) to extract the alphanumerics of the license plate.

An ANPR system can be used to store the images captured by the cameras as well as the decoded alphanumerics from the license plate, which may be cross-linked to an image of the driver, email addresses, telephone numbers, street address, mailing address, GPS location, time and date information, make, model, and color of the vehicle, student identification photo and information, employee identification photo and information, etc. The camera used to capture the image of the license plate, or registration plate, may also include infrared lighting so the camera can take a picture any time of the day.

CCTV (Closed-Circuit TV) Camera 120 is used to acquire images, and is connected to a network, such as, but not limited to, a point-to-point network, a mesh network, etc., to transmit encoded signals to a digital video recorder data storage system, and/or a defined set of monitors. CCTV Camera 120 can be an IP-based camera, which may be equipped with megapixel sensors. Only one CCTV Camera 120 is illustrated, but it will be apparent to one skilled in the art that the present invention's advanced security system can employ a multiplicity of cameras.

In addition to capturing fixed fields of view, CCTV Camera 120 can be configured as PTZ (pan, tilt, zoom) cameras to increase the area of visual coverage of any particular camera. CCTV Camera 120 can operate from a fixed point in space, or a mobile point in space.

CCTV Camera's 120 captured images can be analyzed by an application configured as software, firmware, and embedded in hardware that is capable of isolating at least one license plate 123, and/or at least one face 122, and/or motion 121 across the field of view, and/or ambient light intensity, temperature, the color rendering index (CRI), lumens, etc., color, make, and model of a vehicle, 1D and 2D bar codes, such as, but not limited to, Code 39, Code 39 extended, Danish PTT 39 Bar code, French Postal 39 A/R, German Postal Bar code Identcode 11, German Postal Bar code Leitcode 13, 2 of 5 Interleaved, 2 of 5 Industrial, 2 of 5 Matrix Plessey, Codabar, MSI Plessey, MSI Plessey+CHK10, MSI Plessey+CHK10+CHK10, MSI Plessey+CHK11+CHK10, 2 of 5 IATA, 2 of 5 Datalogic, Code 39 Reduced, USPS tray label, USPS sack label, Code32, Codabar Rationalised, MSI Plessey+CHK11, OMR, Code 93, Code 93 extended, 128 A, 128 B, 128 C, UCC-128, EAN/JAN-8, EAN/JAN-8+2, EAN/JAN-8+5, EAN/JAN-13, EAN/JAN-13+2, EAN/JAN-13+5, UPC-A, UPC-A+2, UPC-A+5, UPC-E, UPC-E+2, UPC-E+5, Oce UNICODE, 128 utoswitch, EAN 128, ISBN, ISSN, Swiss Postal, Code11, UPS Standard (18 digits), UPS 18 digits, UPS Standard (11 digits), UPS 11 digits, 128 X (Free Type), Telepen, PDF-417, PDF-417 (HP Mode), MicroPDF417, Royal Mail 4-State Customer Code, Dutch 4-State Postal, Singapore Post 4-State Postal Code, Australia Post 4-State Postal Code, Japan Post 4-State Postal Code, Australia Post 4-State Postal Code 37,52,67, Australia 4-state postal 37-GUST (HP Mode), Australia 4-state postal 52-FF-MET (HP Mode), Australia 4-state postal 67-FF-MET (HP Mode), Australia 4-state postal FCC-45 REPLY (HP Mode), Singapore Post 4-State Postal Code (HP Mode), DataMatrix, MaxiCode, MaxiCode (HP Mode), USPS FIM, POSTNET 5 ZIP+4, POSTNET 9 ZIP+4, POSTNET 11 DPC, PLANET, Aztec, Aztec Mesas, QR Code, Code 49, Channel Code, Code One, SuperCode, RSS, EAN/UCC Composite Symbology, Codablock F, Dot Code A, Code16K.

These aforementioned bar codes may also use data tags as an integral part of the source data, which can be used to facilitate the input of data into an electronic document, and/or back-end system, and/or software application, and/or firmware, and/or embedded hardware. Primarily within the present invention, data tags are an integral part of the data that has been summed up and displayed in at least one 1D and/or 2D bar codes by a software app, firmware, or embedded hardware, in order to facilitate data interchange to targeted software applications and/or devices. Also, embedded data tags in bar codes may be used by a targeted software app, and/or targeted firmware, and/or targeted embedded hardware, to facilitate various activities, such as, but not limited to, raising or lowering a security gate, unlocking a door, initiating an image capture of a face 122 or license plate 123, launching a web page, etc.

Security app 100 can operate private cellular network software such as, but not limited to, the Quortus EdgeCentrix Platform. The Quortus EdgeCentrix Platform combines all the main elements of a GSM and 3G core network that traditionally would take up several racks worth of equipment into a compact software application. The essential functionality of an HLR/AuC, MSC, SMSC, femto gateway and SGSN/GGSN are all included to create a private cellular network ready for standalone use or for interconnect into IP-PBXs or the PSTN using SIP.

The Quortus EdgeCentrix Platform supports a range of GSM, 3G UMTS and 4G radio transmitters from a range of vendors, giving unique flexibility for a single core network package. Multiple transmitters may be supported on one core, even from different types—for example, GSM picocells and 3G femtocells (illustrated in FIG. 1 as Micro Cell 151) maybe supported simultaneously and calls made seamlessly between them.

The Quortus EdgeCentrix Platform can run on standard Intel PC servers for higher capacity, on embedded ARM processors where small physical size and low power consumption is important and also as an application on the Cisco ISR router SRE modules, for close integration with enterprise voice networks.

Face 122 is a human face, which includes features such as, but not limited to, hair, foreheads, eyebrows, eyelashes, eyes, nose, ears, cheeks, mouths, lips, philtrum, temples, teeth, skin, and chins. In addition, the face 122 is capable of various expressions that make it unique. Face 122 can be captured electronically, analyzed, and correlated to a database in order to be identified within a surveillance network to grant or deny access, to grant or deny permission, etc. Face 122 can be cross-correlated to an email addresses, telephone numbers, street address, mailing address, GPS location, time and date information, make, model, and color of the vehicle, student identification photo and information, employee identification photo and information, etc.

License Plate 123 is a metal or plastic plate attached to a motor vehicle or trailer for official identification purposes. The registration identifier is a numeric or alphanumeric code that uniquely identifies the vehicle within the issuing region's database. In some countries, the identifier is unique within the entire country, while in others it is unique within a state or province. Whether the identifier is associated with a vehicle or a person also varies by issuing agency. Depending on the country, the vehicle registration plate may also be known as license plates, license tags, number plates, or registration plates.

License plate 123 can be captured electronically, analyzed, and correlated to a database in order to be identified within a surveillance network to grant or deny access, to grant or deny permission, etc. License plate 123 can be cross-correlated to an image of the driver, email addresses, telephone numbers, street address, mailing address, GPS location, time and date information, make, model, and color of the vehicle, student identification photo and information, employee identification photo and information, etc.

Bluetooth WAP 130 wireless access point (WAP) that operates using the Bluetooth Low Energy (BLE) feature of the Bluetooth 4.0 protocol, which is a wireless radio technology aimed at new, principally low-power and low-latency, applications for wireless devices within a short range (up to 50 meters/160 feet). Bluetooth WAP 130 wireless access point can also operate as a sniffer only, which acquires the electronic signature and/or ID of Bluetooth-, or BLE-enabled devices operating with range.

Devices using BLE wireless technology consume a fraction of the power of classic Bluetooth enabled products for Bluetooth communication. One of the benefits of BLE is that in many cases, products will be able to operate more than a year on a button cell battery without recharging. It will allow sensors such as thermometers, and transponders to operate continuously, communicating intermittently with other devices, such as, but not limited to, cellphones, wireless access points, etc.

BLE's lower power consumption is not achieved by the nature of the active radio transport, but by the design of the protocol to allow low duty cycles, and by the use cases envisaged. A Bluetooth low energy device used for continuous data transfer would not have a lower power consumption than a comparable Bluetooth device transmitting the same amount of data. It would likely use more power, since the protocol is optimized for small bursts.

The wireless access point feature of BLE WAP 130 is used to connect wireless transmission to a wired network using the Bluetooth standards. The wireless access point can connect to a separate router on a wired network, or the router and wireless access point can be integrated into the same form factor.

In the context of the present invention, a wireless access point is being used to describe a connection point for a peer to peer wireless ad hoc network. Ad hoc networks use a connection between two or more devices without using what is normally called in industry, a wireless access point (WAP).

A wireless ad hoc network is a decentralized wireless network. The network is ad hoc because it does not rely on a preexisting infrastructure, such as routers in wired networks or access points in managed infrastructure wireless networks. Instead, each node participates in routing by forwarding data for other nodes, so the determination of which nodes forward data is made dynamically on the basis of network connectivity. In addition to the classic routing, ad hoc networks can use flooding for forwarding the data.

An ad hoc network typically refers to any set of networks where all devices have equal status on a network and are free to associate with any other ad hoc network device in link range. Ad hoc network often refers to a mode of operation of IEEE 802.11 wireless networks.

Ad hoc network also refers to an enabled device's ability to maintain link status information for any number of devices in a 1-link, also known as “hop” range, and thus, this is most often a Layer 2 activity. Because this is only a Layer 2 activity, ad hoc networks alone may, or may not support a route-able IP network environment without additional Layer 2 or Layer 3 capabilities.

The decentralized nature of wireless ad hoc networks makes them suitable for a variety of applications where central nodes can't be relied on and may improve the scalability of networks compared to wireless managed networks.

Minimal configuration and quick deployment make ad hoc networks suitable for emergency situations like natural disasters, military conflicts, or electronic surveillance systems being described within the present invention. The presence of dynamic and adaptive routing protocols enables ad hoc networks to be formed quickly.

Wireless ad hoc networks can be further classified by their application:
Mobile Ad-Hoc Networks (MANET)
Wireless Mesh Networks (WMN)
Wireless Sensor Networks (WSN)

BLE WAP's 130 main function is to monitor the electronic serial number of a BLE device, and it's secondary function is to transceive data from a BLE enabled device. Therefore, BLE WAP 130 acts both as a wireless access point, and a peer to peer access point.

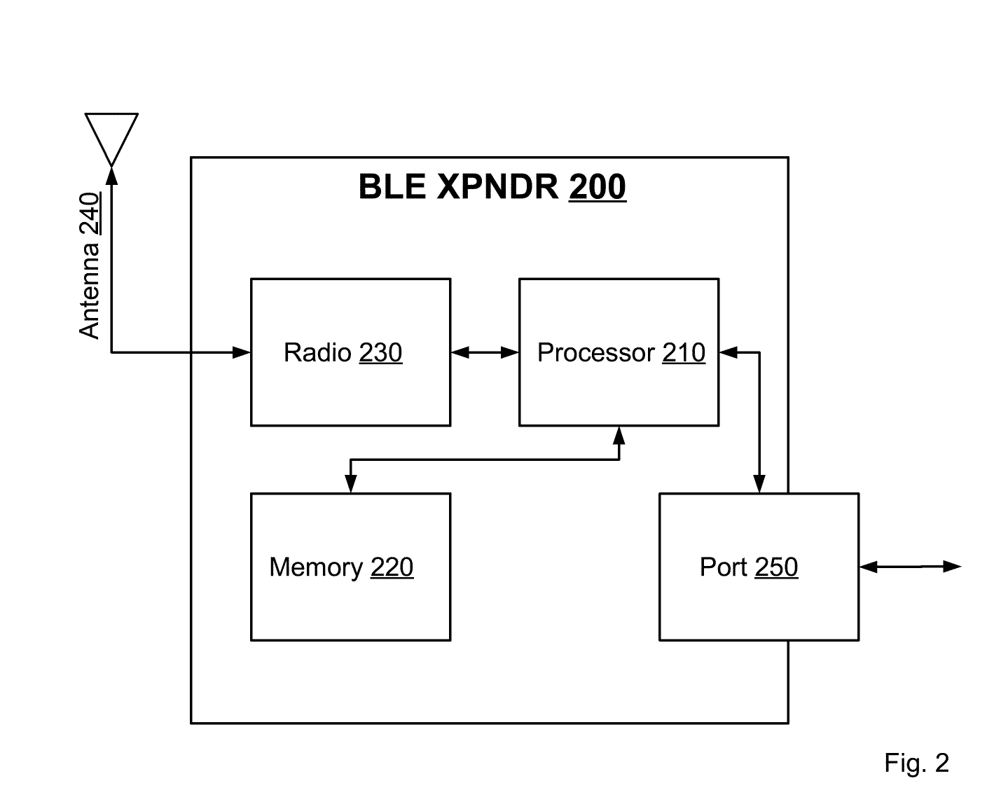

BLE XPNDR 200 (as illustrated in FIG. 2) regularly, or continuously emits an identifying electronic wireless signal, much like a transponder, of which the signal may be encrypted as necessary.

In addition, BLE XPNDR 200 (as illustrated in FIG. 2) functions as a magnetic stripe 132 reader. BLE XPNDR 200 is configured to transmit signals via the Bluetooth Low Energy protocol to other BLE XPNDR 200 (not shown) to a BLE WAP 130, or to a Bluetooth radio integrated into cellphone 140, in which case information contained in BLE XPNDR 200 can be transmitted via the cellphone 140 cellular radio (not shown), and/or cellphone 140 Wi-Fi radio (not shown), or can be presented as a mobile bar code on cellphone 140 display (not shown).

BLE XPNDR 200 (as illustrated in FIG. 2) can be located using a network of BLE WAP 130 devices.

Alternatively, BLE XPNDR 200 (as illustrated in FIG. 2) co-located with cellphone 140 can be located using a hybrid positioning network designed to locate a cellphone singularly, or via any combination of GPS triangulation, Wi-Fi WAP triangulation, and cell tower triangulation.

Alternatively, BLE XPNDR 200 (as illustrated in FIG. 2) can be located using a hybrid positioning network consisting of GPS triangulation, Wi-Fi WAP triangulation, cell tower triangulation, and BLE WAP network triangulation.

Alternatively, BLE XPNDR 200 can be configured to transmit and receive signals according to at least one protocol, such as, but is not limited to, MiWi, Wi-Max, CDMA, TDMA, RFID, Satellite, etc., to accomplish the goals of the present invention.

Mag-Stripe 132 is a magnetic stripe card capable of storing data by modifying the magnetism of tiny iron-based magnetic particles on a band of magnetic material on the card. The magnetic stripe, sometimes called swipe card or mag-stripe, is read by swiping past a magnetic reading head.

A number of International Organization for Standardization standards, ISO/IEC 7810, ISO/IEC 7811, ISO/IEC 7812, ISO/IEC 7813, ISO 8583, and ISO/IEC 4909, now define the physical properties of the card, including size, flexibility, location of the mag-stripe, magnetic characteristics, and data formats. They also provide the standards for financial cards, including the allocation of card number ranges to different card issuing institutions.

Mag-Stripe 132 may be located on an access badge as a credential used to gain entry to an area having automated access control entry points. Entry points may be doors, turnstiles, parking gates or other barriers.

The access badge contains a number that is read by a card reader. The number is sent to an access control system, a computer system that makes access control decisions based on information about the credential. If the credential is included in an access control list, the access control system unlocks the controlled access point. The transaction is stored in the system for later retrieval; reports may be generated that reveal who entered what controlled access point at what time.

Mag-Stripe 132 may be located on a smart card, also known as a chip card, or as an integrated circuit card (ICC), which is any pocket-sized card with embedded integrated circuits. Smart cards are made of plastic, generally polyvinyl chloride, but may also be constructed of polyethylene terephthalate-based polyesters, acrylonitrile butadiene styrenes, polycarbonates, etc.

Smart cards can provide identification, authentication, data storage and application processing. Smart cards may provide strong security authentication for single sign-on (SSO) within large organizations, such as, but not limited to, public schools, colleges, universities, government offices, corporations, etc.

Mag-Stripe 132 may also be located on an affinity card, which is designed for organizations to offer its members and supporters those who have an “affinity” for that organization. The affinity card may be configured such as, but not limited to, a debit or credit card branded with an organization's brand and imagery, a student identification card, or an employee identification card, etc.

Affinity debit and credit cards may be offered by many retailers, shopping centers, airlines, universities, alumni associations, sports teams, professional associations and others, and increasingly by small and mid-sized nonprofits and membership-based groups that rely on these programs for incremental revenue.

Mag-Stripe Feed 133 can be inserted and read by BLE XPNDR 200.

Cellphone 140 may be configured as a smart-phone, which is a mobile phone built on a mobile operating system. Most modern smart-phones also include high-resolution touchscreens and web browsers that display standard web pages as well as mobile-optimized sites. High-speed data access is provided by Wi-Fi and mobile broadband. In recent years, the rapid development of mobile app markets and mobile commerce have been drivers of smart-phone adoption.

The mobile operating systems (OS) used by modern smart-phones include Google's Android, Apple's iOS, Nokia's Symbian, RIM's BlackBerry OS, Samsung's Bada, Microsoft's Windows Phone, Hewlett-Packard's webOS, and embedded Linux distributions such as Maemo and MeeGo. Such operating systems can be installed on many different phone models, and typically each device can receive multiple OS software updates over its lifetime. A few other upcoming operating systems are Mozilla's Firefox OS and Canonical Ltd.'s Ubuntu Phone.

Cellphone 140 typically includes a processor, which is at least one integrated circuit (IC) that accepts digital data as input, processes it according to instructions stored in its memory, and provides results as output. The processor is a sequential digital logic device that is operatively connected to memory, and at least one element carries out arithmetic and logic operations, and a sequencing and control element that can change the order of operations based on the information that is stored in the memory. The security app 100 is capable of communicating instructions to cellphone 140 via at least one type of wireless port (not shown).

Cellphone 140 includes memory (not shown), which is at least one physical device used to store programs (sequences of instructions) or data (e.g. program state information) on a temporary or permanent basis for use in controlling and interacting with security app 100, and/or BLE XPNDR 200.

Cellphone 140 memory is typically addressable semiconductor-based memory, such as, but not limited to, an integrated circuit. Cellphone 140 memory (not shown) can be primary and/or secondary memory. Furthermore, cellphone 140 memory (not shown) can be volatile and/or non-volatile memory. Cellphone 140 memory (not shown) can be constructed using technologies such as, but not limited to, ROM, PROM, EPROM, EEPROM, RAM, DRAM, static RAM, static SRAM, etc.

Cellphone 140 typically also includes at least one non-voice wireless port (not shown) enabled to communicate via Wi-Fi, and/or Bluetooth, and a hardwire port.

Cellphone 140 non-voice wireless port(s) (not shown) can be configured and constructed to operate using a technology such as, but not limited to, Wi-Fi, Bluetooth, Bluetooth Low Energy (BLE), etc.

Wi-Fi 110A, 110B are Wi-Fi wireless access points that permit Wi-Fi-enabled devices to connect to the Internet when within range. In addition, Wi-Fi 110A, 110B can act as sniffers to acquire the electronic signature and ID of Wi-Fi-enabled devices operating within their range.

Wi-Fi can provide service in private homes, businesses, as well as in public spaces. Wi-Fi routers can be specified to incorporate a digital subscriber line modem or a cable modem.

Similarly, there are battery-powered routers that include a cellular mobile Internet radio-modem and Wi-Fi access point. When subscribed to a cellular phone carrier, they allow nearby Wi-Fi stations to access the Internet over 2G, 3G, or 4G networks. Many smartphones have a built-in capability of this sort, including those based on Android, Bada, iOS (iPhone), Windows Phone and Symbian,

“Internet pucks” provide standalone facilities of this type as well, without use of a smartphone; examples include the MiFi- and WiBro-branded devices. Some laptops that have a cellular modem card can also act as mobile Internet Wi-Fi access points.

Wi-Fi is a popular technology that allows an electronic device to exchange data wirelessly (using radio waves) over a network. In the broadest sense, Wi-Fi is defined as any wireless local area network (WLAN) product, or device, that is based on IEEE 802.11 standards. Wi-Fi can be used to interconnect devices, such as, but not limited to, personal computers, video-game consoles, video-game controllers, smart-phones, tablets, digital audio players, etc. Wi-Fi standards can be used to allow enabled devices to interconnect through a wireless access point, or peer-to-peer.

Bluetooth is a wireless technology standard for exchanging data over short distances using short-wavelength radio transmissions in the ISM band from 2400-2480 MHz from fixed and mobile devices, to create personal area networks (PANs) with high levels of security. Bluetooth can connect several devices, which overcomes the problems of synchronization.

Bluetooth Low Energy (BLE) is a feature of Bluetooth 4.0 wireless radio technology, aimed at new, principally low-power and low-latency, applications for wireless devices within a short range of up to 160 feet.

Bluetooth Low Energy technology (2.45 GHz) has become an attractive alternative to Near Field Communication (NFC 13.56 MHz) as a short-range communication technology, due to its low power consumption and greater range. Allowed transmission power for NFC 13.56 MHz is strongly limited, restricting range. In contrast to NFC, Bluetooth Low Energy has a range of 50 meters. Bluetooth Low Energy technology set-up time has been designed to be faster than classic Bluetooth technology.

Bluetooth Low Energy achieves its phenomenal success through the design of the protocol to allow low duty cycles.

Several chip suppliers have released Bluetooth Low Energy chips. Some of these offered chip designs include the entire protocol suite implementation, others allow for special implementing strategies. Some of these chip designs allow for dynamic change of protocol suites even outside the Bluetooth technology/Bluetooth Low Energy (BLE) standard, others are designed for a single protocol suite. Bluetooth Low Energy chipsets are available from companies such as, but not limited to, Broadcom, CSR, EM Microelectronic, Nordic Semiconductor, Texas Instruments, etc.

Cellphone 140 also includes a wireless port (not shown) for cellular communications, and can be configured and constructed to operate using a technology such as, but not limited to, GSM, CDMA, TDMA, etc. Voice and/or General Packet Radio Service (GPRS) data packets, can be transported over this type port.

Cellphone 140 hardwire port(s) (not shown) can be configured and constructed using a technology such as, but not limited to, USB, USB Type-A, USB Type-B, USB Mini A, USB Mini B, Micro-A USB, USB Micro B, eSATA, Firewire, Component Video, HDMI, DisplayPort, DVI, S-Video, VGA, etc.

Cellular Network 150 is a mobile network, which is a radio network distributed over land areas called cells, each served by at least one fixed-location transceiver, known as a cell site or base station. In a cellular network 150, each cell uses a different set of frequencies from neighboring cells, to avoid interference and provide guaranteed bandwidth within each cell.

When joined together these cells provide radio coverage over a wide geographic area. This enables a large number of portable transceivers (e.g., mobile phones, pagers, etc.) to communicate with each other and with fixed transceivers and telephones anywhere in the network, via base stations, even if some of the transceivers are moving through more than one cell during transmission.

Micro Cell 151 is a cell in a mobile phone network served by a low power cellular base station, covering a limited areas such as, but not limited to, a school campus, a business campus, a hotel, a parking lot, an airport, a train station, a high rise building, a bus, a train, etc. Micro Cell 151 is usually larger than a picocell, though the distinction is not always clear. Micro Cell 51 uses power control to limit the radius of its coverage area. A Micro Cellular network is a radio network composed of Micro Cells.

Typically the range of a Micro Cell 151 is less than two kilometers wide, whereas a standard base station in a cellular network may have ranges of up to 35 kilometers (22 mi). Picocells, on the other hand, is 200 meters or less, and a femtocell is on the order of 10 meters. intelligent 3G and LTE small cells

As an example, one company, Ubiquisys, provides Micro Cellular technology that includes the following features:

ActiveRadio® Radio Resource Management—Unique radio resource algorithms, which mean that the unit(s) explore the radio environment to optimize the service provided within the home, while at the same time minimizing any possible disruption to the external macro network. These algorithms also enable full plug-and-play for the enterprise by providing the ability to activate and upgrade small cells remotely, without affecting service.

Provisioning And Automatic Setup—Small cells are pre-provisioned with basic configuration parameters, so they know who they are and who they belong to. Once plugged in at the enterprise, operator policies are downloaded and the small cells simply adjust the radio configuration according to local conditions, within these policies. They are then automatically activated in a matter of minutes.

Listen Mode, UL/DL Power Setting—The small cell contains a down-link Listen Mode, which measures the interference levels of surrounding macro and small cells. Using Listen Mode, the Small Cell selects the settings for optimal performance for users of the small cell, while minimizing the interference to the macro according to the operator's policies.

Dynamic Code and Down-link Power Reallocation—The small cell supports down-link power reallocation between individual data channels or between data channels and HSDPA.

Up/Down-link Power Adaptation—The small cell initially sets its power levels based on the received signal levels it experiences from the macro network, in order to minimize up-link interference, including adjacent channel interference mitigation. These values are then dynamically altered according to the actual levels reported by the end user device through measurement reports.

Continuous Fast Sniff—The small cell uniquely uses an active sniff mode during normal operation to monitor changes in the radio environment—without affecting calls.

Below is a brief summary of the key call features Ubiquisys Micro Cells support:
8/16-call
Video Calling Support
Supplementary Services Support
HD voice (WBAMR)
Emergency Calls
HSDPA 14.4 Mbps
HSUPA 5.76 Mbps
Multiple Primary PDP Contexts
Cell FACH
Basic Data Rate Adaptation
Non-Standard UE Profiling & Corrective Actions
Advanced Data Rate Adaptation (Voice Priority)

Cell Tower 152 is a site where antennas and electronic communications equipment are placed, usually on a radio mast, tower or other high place, to create a cell (or adjacent cells) in a cellular network. The elevated structure typically supports antennas, and one or more sets of transmitter/receiver transceivers, digital signal processors, control electronics, a GPS receiver for timing (for CDMA2000/IS-95 or GSM systems), primary and backup electrical power sources, and sheltering.

A cell site is sometimes called a “cell tower”, even if the cell site antennas are mounted on a building rather than a tower. In GSM networks, the technically correct term is Base Transceiver Station (BTS), and colloquial British English synonyms are “mobile phone mast” or “base station”. The term “base station site” might better reflect the increasing co-location of multiple mobile operators, and therefore multiple base stations, at a single site. Depending on an operator's technology, even a site hosting just a single mobile operator may house multiple base stations, each to serve a different air interface technology (CDMA2000 or GSM, for example).

Local Network 160 is a collection of computers and other hardware interconnected by wired and/or wireless communication channels that allow sharing of resources and information, where at least one process in one device is able transmit/receive data to/from at least one process residing in a remote device. Communication protocols define the rules and data formats for exchanging information within a computer network.

Local Network 160 may also be partially configured as a Voice over IP network (VoIP), which refers to the communication protocols, technologies, methodologies, and transmission techniques involved in the delivery of voice communications and multimedia sessions over Internet Protocol (IP) networks, such as the Internet. Other terms commonly associated with VoIP are IP telephony, Internet telephony, voice over broadband (VoBB), broadband telephony, IP communications, and broadband phone.

Internet telephony also refers to communications services, such as, but not limited to, voice, fax, SMS, and/or voice-messaging applications that are transported via the Internet, rather than the public switched telephone network (PSTN). The steps involved in originating a VoIP telephone call are signaling and media channel setup, digitization of the analog voice signal, encoding, packetization, and transmission as Internet Protocol (IP) packets over a packet-switched network. On the receiving side, similar steps (usually in the reverse order) such as reception of the IP packets, decoding of the packets and digital-to-analog conversion reproduce the original voice stream. Even though IP telephony and VoIP are used interchangeably, IP telephony refers to all use of IP protocols for voice communication by digital telephony systems, while VoIP is one technology used by IP telephony to transport phone calls.

VoIP systems employ session control protocols to control the set-up and tear-down of calls as well as audio codecs which encode speech allowing transmission over an IP network as digital audio via an audio stream. The choice of codec varies between different implementations of VoIP depending on application requirements and network bandwidth; some implementations rely on narrow-band and compressed speech, while others support high fidelity stereo codecs. Some popular codecs include u-law and a-law versions of G.711, G.722 which is a high-fidelity codec marketed as HD Voice by Polycom, a popular open source voice codec known as iLBC, a codec that only uses 8 kbit/s each way called G.729, and many others.

VoIP is now available on many cellphones, especially smartphones, and various Internet devices, to place calls or send SMS over 3G, 4G or Wi-Fi.

Internet 170 is a global system of interconnected computer networks that use the standard Internet protocol suite (TCP/IP) to serve billions of users worldwide. This network of networks consists of millions of private, public, academic, business, and government networks, that are local to global in scope, linked by a broad array of electronic, wireless and optical networking technologies. The Internet 170 carries a vast range of information resources and services. Internet 170 can be accessed via hard-wired and/or wireless networks, hard-wired networks such as, but not limited to, fiber optic networks, coax networks, hybrid fiber-coax networks, telephony-type networks, computer-type networks, virtual private-type networks, wide area-type wired networks, local area-type wired networks, metropolitan area-type wired networks, campus area-type wired networks, etc.; and/or wireless networks, such as, but not limited to, Bluetooth networks, wireless local area networks, RFID networks, Wi-Fi networks, cellular networks, WiMAX, WiLAN, mobile networks, wireless personal area networks, wireless mesh networks, ultra wide-band networks, etc.

LED Light 180 is a solid-state fixture, or luminaire, and uses light-emitting diodes (LEDs) as the lamps, or the source of the light. The LEDs involved may be devices such as, but not limited to, conventional semiconductor light-emitting diodes, organic LEDs (OLED), or polymer light-emitting diode (PLED) devices, although PLED technologies are not generally commercially available.

LED Light 180 may include optional sensors (not shown), which are devices that measure a physical quantity and convert it into a signal which can be read by an observer or by an instrument. For example, a thermocouple converts temperature to an output voltage which can be read by a voltmeter. Examples of optional sensors include, but are not limited to, microphones, carbon dioxide sensors, carbon monoxide detectors, chemical field-effect transistors, electrochemical gas sensors, holographic sensors, infrared sensors, non-dispersive infrared sensors, microwave chemistry sensors, nitrogen oxide sensor, olfactometers, optodes, oxygen sensors, pellistors, potentiometric sensors, redox electrodes, smoke detectors, zinc oxide nanorod sensors, electric current meters, electric potential, magnetic sensors, ammeters, current sensors, galvanometers, hall effect sensors, magnetic anomaly detector, magnetometers, MEMS magnetic field sensors, metal detectors, multimeters, ohmmeters, radio direction finders, voltmeters, voltage detectors, watt-hour meters, humidity sensors, air flow meters, Geiger counters, neutron detectors, photoelectric sensors, motion detectors, charge-coupled devices, calorimeters, electro-optical sensors, flame detectors, kinetic inductance detectors, LEDs as light sensors, light-addressable potentiometric sensors, Nichols radiometers, fiber optic sensors, photo-detectors, photo-diodes, photo-transistors, photoelectric sensors, photo-ionization detector, photo-multipliers, photo-resistors, photo-switches, photo-tubes, scintillometers, visible light photon counters, barometers, pressure sensors, load cells, magnetic level gauges, strain gauges, bolometers, bi-metallic strips, infrared thermometers, microbolometers, microwave radiometers, net radiometers, quartz thermometers, resistance temperature detectors, resistance thermometers, silicon bandgap temperature sensors, thermistors, thermocouples, thermometers, alarm sensors, occupancy sensors, proximity sensors, passive infrared sensors, reed switches, triangulation sensors, bio-sensors, radar, ground penetrating radar, synthetic aperture radar. These sensors may use technology such as, but not limited to, active pixel sensors, back-illuminated sensors, catadioptric sensors, carbon paste electrodes, displacement receivers, electromechanical film, electro-optical sensors, Fabry-Pérot interferometers, image sensors, inductive sensors, machine vision technology. micro-electromechanical systems, micro-sensor arrays, photo-elasticity, sensor fusion, sensor grids, sensor nodes, sonar, transducers, ultrasonic sensors, video sensors, visual sensor networks, Wheatstone bridges, wireless sensor networks, frame grabbers, intensity sensors, chemo-receptors, compressive sensing, hyper-spectral sensors, millimeter wave scanners, magnetic resonance imaging, diffusion tensor imaging, functional magnetic resonance imaging, molecular sensors, etc.

LED Light 180 may integrate other devices (not shown), which can include technology such as, but not limited to, Radio Frequency Identification (RFID) readers, barcode readers, cameras, wired and wireless switches, wired and wireless routers, wired and wireless hubs, alarms, femto-cells, pico-cells, micro-cells, smart card readers, etc.

LED Light 180 may also include integrated Modified Power-over-Ethernet, as described in U.S. patent application Ser. No. 14/108,938, which is incorporated by reference in its entirety herein, capabilities, such as Modified Power Sourcing Equipment (MPSE) (not shown), which is a device, such as, but not limited to a switch. MPSE can transmit/receive data, and source power, combined on a Common Ethernet Cable 197 that feeds a Modified or Standard Powered Device (PD) not shown.

When a MPSE device is a switch, it's called an endspan in Ethernet vernacular. Otherwise, if it's an intermediary device between a non-combined low voltage power/data cabling capable switch and a combined low voltage power/data cabling device, it's called a midspan. An external combined low voltage power/data cabling injector is a midspan device.

A Modified Powered Device (MPD) or standard Powered Device (PD) is powered by PSE. Some examples of PDs include, but not limited to, wireless access points, IP Phones, IP cameras, etc.

Many types of MPDs or PDs have an auxiliary power connector for an optional, external, power supply. Depending on the MPD or PD design, some, none, or all power can be supplied from an auxiliary port, with the auxiliary port sometimes acting as backup power in case of power failure.

The Flat Panel Lighting System (FPLS) LED Light 180 is the preferred design form to integrate the present invention. The FPLS design form replaces 40+ year old fluorescent tube technology, which represents approximately 80% of the indoor lighting market.

The FPLS (LED 180) is simple to assemble, constructed of durable materials, is efficient, produces indirect lighting, and has a favorable Power Factor. Other benefits of the design form include:
Sanitizable surface made with non-yellowing materials
Shatterproof lens for vandal proof applications
Indirect lighting for zero-glare and even distribution
“Zero” clearance installation and optimized packaging profile.
Efficient assembly from component to completion in approximately 5 minutes

The Flat Panel LED Light design form has been embraced by correctional facilities and educational institutions for its vandal resistant qualities. Hospitals and assisted living facilities like its full light spectrum, dimming capabilities, and zero plenum exchange. The food service industry enjoys its clean-ability, and the list continues. As a stand-alone prior art product, the FPLS is highly marketable and widely accepted.

The present invention uses a “smart” FPLS design form, and using “Modified Power-over-Ethernet” features, modular ports, and high speed data transmission over virtually any wire, the FPLS becomes a smart fixture that is an integrated part of any computer network.

Each FPLS smart fixture can be IP addressable, and include integrated modular ports for communications, sensors, cameras, RFID interrogators, etc. Communication systems that can be co-located with a FPLS fixture include, Wi-Fi, Bluetooth 4.0, cellular network femto-cells, etc. Sensors that may be plugged into a SMART fixture's ports include, motion, CO2, temperature, etc. In addition, in the back-end, the FPLS smart fixtures can be integrated with third-party software and systems, such as, smart grids, building management systems, security systems, etc.

Very inexpensive “cell-phone type” cameras can be integrated in the fixtures to provide ambient light sensing to trigger switches to turn individual lights on/off, and control dimming. They can also be used as motion detectors to drive security systems, for machine vision image capture to drive a barcode decoding engine, optical character recognition (OCR), etc.

In addition, FPLS LED Lights can be used as a core piece in the present invention's Identify Friend or Foe (IFF) electronic surveillance system. Cell phones, Bluetooth Low Energy transponders, and Wi-Fi signals can all be part of a comprehensive system to electronically detect, locate, and monitor the movement of individuals, vehicles, and assets in corporate offices, factories, warehouses, college campuses, automobile dealer lots, parking garages, etc. Femtocells (aka Microcells) (miniature cellphone towers), Bluetooth transceivers, and Wi-Fi routers can be co-located with Flat Panel LED Lights to create an extensible combined power/data network. This combined network will be capable of delivering power to flat panel LEDs' over either low or high voltage wiring, and also transmit/receive data over the same low or high voltage wiring used to power the lights.

LED Light 180 can include optional hardwire port interfaces (not shown) to transmit/receive data via standard audio, video, and computer equipment jack and ports include, but are not limited to: connectors for twisted pair cable include the modular RJ type of jacks and plugs (RJ-11; RJ-14; RJ-22; RJ-25; RJ-31; RJ-45; RJ-48; RJ-61) (of four, six, and eight position configurations) along with the hermaphroditic connector employed by IBM. The hermaphroditic connector is specific to shielded twisted pair (STP) and is also known as a STP connector, IBM data connector, or universal data connector. The connector used with patch panels, punch-down blocks, and wall plates, is called an IDC (insulated displacement connector). Modular Y-adapters used for splitting usually in 10Base-T, Token Ring, and voice applications. Also, crossover cables which are wired to a T586A pin-out scheme on one end and a T586B pin-out on the other end. Coax connectors used with video equipment are referred to as F-series connectors (primarily used in residential installations for RG-58, RG-59, and RG-6 coaxial cables). Coax cables used with data and video backbone applications use N-connectors (used with RG-8, RJ-11U, and thicknet cables). When coaxial cable distributes data in commercial environments, the BNC (Bayonet Niell-Concelman) connector is often used. It is used with RG-6, RG-58A/U thinnet, RG-59, and RG-62 coax cable. Fiber-optic connectors include SC, duplex SC, ST, duplex ST, FDDI, and FC. These relate to different types of fiber-optic cables and configurations. Three of the SFF connectors that have recently been propagated (for fiber-optic cables are LC, VF-45, and the MT-RJ, etc.

Transmission Paths 190A, 190B, 190C, 190D, 190E, 190F, 190G, 190H, 190J, 190K, 190L, 190M are electrically conductive, or photonic cables capable of transmitting/receiving data.

The data being transmitted/received over a wire in the present invention can be native or encapsulated in packets in the present invention using a wide variety of protocols such as, but not limited to, MOCA, Home PNA, HomePlug Standard, tZero UltraMIMO, Modem 110 baud, Modem 300 baud (V.21), Modem Bell 103 (Bell 103), Modem 1200 (V.22), Modem Bell 212A (Bell 212A), Modem 2400 (V.22bis), Modem 9600 (V.32), Modem 14.4 k (V.32bis), Modem 19.2 k (V.32terbo), Modem 28.8 k (V.34), Modem 33.6 k (V.34plus/V.34bis), Modem 56 k (V.90), and Modem 56 k (V.92), 64 k ISDN and 128 k dual-channel ISDN, Serial RS-232, Serial RS-232 max, USB Low Speed, Parallel (Centronics), Serial RS-422 max, USB Full Speed, SCSI 1, Fast SCSI 2, FireWire (IEEE 1394) 100, Fast Wide SCSI 2, FireWire (IEEE 1394) 200, Ultra DMA ATA 33, Ultra Wide SCSI 40, FireWire (IEEE 1394) 400, USB Hi-Speed, Ultra DMA ATA 66, Ultra-2 SCSI 80, FireWire (IEEE 1394b) 800, Ultra DMA ATA 100 800, Ultra DMA ATA 133, PCI 32/33, Serial ATA (SATA-150), Ultra-3 SCSI 160, Fibre Channel, PCI 64/33, PCI 32/66, AGP 1×, Serial ATA (SATA-300), Ultra-320 SCSI, PCI Express (×1 link), AGP 2x, PCI 64/66, Ultra-640 SCSI, AGP 4x, PCI-X 133, InfiniBand, PCI Express (×4 link), AGP 8x, PCI-X DDR, HyperTransport (800 MHz, 16-pair), PCI Express (×16 link), iSCSI (Internet SCSI), and HyperTransport (1 GHz, 16-pair), IrDA-Control, 802.15.4 (2.4 GHz), Bluetooth 1.1, 802.11 legacy, Bluetooth 2, RONJA free source optical wireless, 802.11b DSSS, 802.11b+ non-standard DSSS, 802.11a, 802.11g DSSS, 802.11n, 802.16 (WiBro) and 802.16 (Hiperman), GSM CSD, HSCSD, GPRS, UMTS, CDMA, TDMA, DS0, Satellite Internet, Frame Relay, G.SHDSL, SDSL, ADSL, ADSL2, ADSL2Plus, DOCSIS (Cable Modem), DS1/T1, E1, E2, E3, DS3/T3, OC1, VDSL, VDSL, VDSL2, OC3, OC12, OC48, OC192, 10 Gigabit WAN PHY, 10 Gigabit LAN PHY, OC256, and OC768, LocalTalk, ARCNET, Token Ring, (10base-X), Fast (100base-X), FDDI, and Gigabit (1000 base-X), Intelligent Transportation System Data Bus (ITSDB), MIL-STD-1553, VoIP (Voice over IP) standard signaling protocols, such as, but not limited to, H.323, Megaco H.248 Gateway Control Protocol, MGCP Media Gateway Control Protocol, RVP over IP Remote Voice Protocol Over IP Specification, SAPv2 Session Announcement Protocol SGCP, Simple Gateway Control Protocol, SIP Session Initiation Protocol, and Skinny Client Control Protocol (Cisco), VoIP (Voice over IP) standard media protocols, such as, but not limited to, DVB Digital Video Broadcasting, H.261 video stream for transport using the real-time transport, H.263 Bitstream in the Real-time Transport Protocol, RTCP RTP Control Protocol, and RTP Real-Time Transport, VoIP (Voice over IP) H.323 suite of standard protocols, such as, but not limited to, H.225 Narrow-Band Visual Telephone Services, H.225 Annex G, H.225E, H.235 Security and Authentication, H.323SET, H.245 negotiates channel usage and capabilities, H.450.1 supplementary services for H.323, H.450.2 Call Transfer supplementary service for H.323, H.450.3 Call Diversion supplementary service for H.323, H.450.4 Call Hold supplementary service, H.450.5 Call Park supplementary service, H.450.6 Call Waiting supplementary service, H.450.7 Message Waiting Indication supplementary service, H.450.8 Calling Party Name Presentation supplementary service, H.450.9 Completion of Calls to Busy subscribers supplementary Service, H.450.10 Call Offer supplementary service, H.450.11 Call Intrusion supplementary service, H.450.12 ANF-CMN supplementary service, RAS Management of registration, admission, status, T.38 IP-based Fax Service Maps, T.125 Multipoint Communication Service Protocol (MCS), VoIP (Voice over IP) SIP suite of standard protocols, such as, but not limited to, MIME (Multi-purpose Internet Mail Extension), SDP (Session Description Protocol), SIP (Session Initiation Protocol), PHY protocols including, but not limited to, LDVS—Low Voltage Differential Signaling, LVTTL—Low Voltage Transistor-Transistor Logic, LVCMOS—Low Voltage Complementary Metal Oxide Semiconductor, LVPECL—Low Voltage Positive Emitter Coupled Logic, PECL—Positive Emitter Coupled Logic, ECL—Emitter Coupled Logic, CML—Current Mode Logic, CMOS—Complementary metal-oxide-semiconductor, TTL—Transistor-Transistor Logic, GTL—Gunning Transceiver Logic, GTLP—Gunning Transceiver Logic Plus, HSTL—High-Speed Transceiver Logic, SSTL—Stub Series Terminated Logic, memory chip access protocols including, but not limited to, SDR (software defined radio), DDR (double data rate), QDR (quad data rate), RS Standards protocols including, but not limited to, RS 232, RS-422-B, RS-423-B, RS-449, RS-485, RS-530, RS 561, RS-562, RS 574, RS-612, RS 613, V-standards protocols including, but not limited to, V.10, V.11, V.24, V.28, V.35, (MAC-PHY) protocols including, but not limited to, XGMII, RGMII, SGMII, GMII, MII, TBI, RTBI, AUI, XAUI, PCB Level Control protocols including, but not limited to, SPI, I.sup.2C, MDIO, JTAG, fiber optic protocols including, but not limited to, SDH, CWDM, DWDM, back-plane protocols including, but not limited to, VMEbus, PC 104A, ATCA, SBus, and other protocols, such as, but not limited to, GFP, Actel and Atmel ARM Microprocessor buses including, but not limited to, Advanced Microcontroller Bus Architecture (AMBA), Advanced High performance Bus (AHB), Xilinx Microblaze microprocessor buses including, but not limited to, Fast Simplex Link (FSL), On-chip Peripheral Bus (OPB), Local Memory Bus (LMB), and Xilinx PowerPC microprocessor buses including, but not limited to, On-chip Peripheral. Bus (OPB), Processor Local Bus (PLB), Device Control Register (DCR) bus, Altera Nios II microprocessor bus including, but not limited to, Avalon Interface, and Latice LatticeMicro32 open IP microprocessor 1core bus including, but not limited to, Wishbone, etc.

Transmission Paths 195A, 195B, 195C, 195D, 195E, 195F, 195G, 195H can be designed to transmit/receive data wirelessly using radio frequency, or free space optics.

Data being transmitted/received wirelessly in the present invention can be native or encapsulated in packets in the present invention using a wide variety of protocols such as, but not limited to, MOCA, Home PNA, HomePlug Standard, tZero UltraMIMO, Modem 110 baud, Modem 300 baud (V.21), Modem Bell 103 (Bell 103), Modem 1200 (V.22), Modem Bell 212A (Bell 212A), Modem 2400 (V.22bis), Modem 9600 (V.32), Modem 14.4 k (V.32bis), Modem 19.2 k (V.32terbo), Modem 28.8 k (V.34), Modem 33.6 k (V.34plus/V.34bis), Modem 56 k (V.90), and Modem 56 k (V.92), 64 k ISDN and 128 k dual-channel ISDN, Serial RS-232, Serial RS-232 max, USB Low Speed, Parallel (Centronics), Serial RS-422 max, USB Full Speed, SCSI 1, Fast SCSI 2, FireWire (IEEE 1394) 100, Fast Wide SCSI 2, FireWire (IEEE 1394) 200, Ultra DMA ATA 33, Ultra Wide SCSI 40, FireWire (IEEE 1394) 400, USB Hi-Speed, Ultra DMA ATA 66, Ultra-2 SCSI 80, FireWire (IEEE 1394b) 800, Ultra DMA ATA 100 800, Ultra DMA ATA 133, PCI 32/33, Serial ATA (SATA-150), Ultra-3 SCSI 160, Fibre Channel, PCI 64/33, PCI 32/66, AGP 1x, Serial ATA (SATA-300), Ultra-320 SCSI, PCI Express (×1 link), AGP 2x, PCI 64/66, Ultra-640 SCSI, AGP 4x, PCI-X 133, InfiniBand, PCI Express (×4 link), AGP 8x, PCI-X DDR, HyperTransport (800 MHz, 16-pair), PCI Express (×16 link), iSCSI (Internet SCSI), and HyperTransport (1 GHz, 16-pair), IrDA-Control, 802.15.4 (2.4 GHz), Bluetooth 1.1, 802.11 legacy, Bluetooth 2, RONJA free source optical wireless, 802.11b DSSS, 802.11b+ non-standard DSSS, 802.11a, 802.11g DSSS, 802.11n, 802.16 (WiBro) and 802.16 (Hiperman), GSM CSD, HSCSD, GPRS, UMTS, CDMA, TDMA, DS0, Satellite Internet, Frame Relay, G.SHDSL, SDSL, ADSL, ADSL2, ADSL2Plus, DOCSIS (Cable Modem), DS1/T1, E1, E2, E3, DS3/T3, OC1, VDSL, VDSL, VDSL2, OC3, OC12, OC48, OC192, 10 Gigabit WAN PHY, 10 Gigabit LAN PHY, OC256, and OC768, LocalTalk, ARCNET, Token Ring, (10base-X), Fast (100base-X), FDDI, and Gigabit (1000 base-X), Intelligent Transportation System Data Bus (ITSDB), MIL-STD-1553, VoIP (Voice over IP) standard signaling protocols, such as, but not limited to, H.323, Megaco H.248 Gateway Control Protocol, MGCP Media Gateway Control Protocol, RVP over IP Remote Voice Protocol Over IP Specification, SAPv2 Session Announcement Protocol SGCP, Simple Gateway Control Protocol, SIP Session Initiation Protocol, and Skinny Client Control Protocol (Cisco), VoIP (Voice over IP) standard media protocols, such as, but not limited to, DVB Digital Video Broadcasting, H.261 video stream for transport using the real-time transport, H.263 Bitstream in the Real-time Transport Protocol, RTCP RTP Control Protocol, and RTP Real-Time Transport, VoIP (Voice over IP) H.323 suite of standard protocols, such as, but not limited to, H.225 Narrow-Band Visual Telephone Services, H.225 Annex G, H.225E, H.235 Security and Authentication, H.323SET, H.245 negotiates channel usage and capabilities, H.450.1 supplementary services for H.323, H.450.2 Call Transfer supplementary service for H.323, H.450.3 Call Diversion supplementary service for H.323, H.450.4 Call Hold supplementary service, H.450.5 Call Park supplementary service, H.450.6 Call Waiting supplementary service, H.450.7 Message Waiting Indication supplementary service, H.450.8 Calling Party Name Presentation supplementary service, H.450.9 Completion of Calls to Busy subscribers supplementary Service, H.450.10 Call Offer supplementary service, H.450.11 Call Intrusion supplementary service, H.450.12 ANF-CMN supplementary service, RAS Management of registration, admission, status, T.38 IP-based Fax Service Maps, T.125 Multipoint Communication Service Protocol (MCS), VoIP (Voice over IP) SIP suite of standard protocols, such as, but not limited to, MIME (Multi-purpose Internet Mail Extension), SDP (Session Description Protocol), SIP (Session Initiation Protocol), PHY protocols including, but not limited to, LDVS—Low Voltage Differential Signaling, LVTTL—Low Voltage Transistor-Transistor Logic, LVCMOS—Low Voltage Complementary Metal Oxide Semiconductor, LVPECL—Low Voltage Positive Emitter Coupled Logic, PECL—Positive Emitter Coupled Logic, ECL—Emitter Coupled Logic, CML—Current Mode Logic, CMOS—Complementary metal-oxide-semiconductor, TTL—Transistor-Transistor Logic, GTL—Gunning Transceiver Logic, GTLP—Gunning Transceiver Logic Plus, HSTL—High-Speed Transceiver Logic, SSTL—Stub Series Terminated Logic, memory chip access protocols including, but not limited to, SDR (software defined radio), DDR (double data rate), QDR (quad data rate), RS Standards protocols including, but not limited to, RS 232, RS-422-B, RS-423-B, RS-449, RS-485, RS-530, RS 561, RS-562, RS 574, RS-612, RS 613, V-standards protocols including, but not limited to, V.10, V.11, V.24, V.28, V.35, (MAC-PHY) protocols including, but not limited to, XGMII, RGMII, SGMII, GMII, MII, TBI, RTBI, AUI, XAUI, PCB Level Control protocols including, but not limited to, SPI, I.sup.2C, MDIO, JTAG, fiber optic protocols including, but not limited to, SDH, CWDM, DWDM, back-plane protocols including, but not limited to, VMEbus, PC 104A, ATCA, SBus, and other protocols, such as, but not limited to, GFP, Actel and Atmel ARM Microprocessor buses including, but not limited to, Advanced Microcontroller Bus Architecture (AMBA), Advanced High performance Bus (AHB), Xilinx Microblaze microprocessor buses including, but not limited to, Fast Simplex Link (FSL), On-chip Peripheral Bus (OPB), Local Memory Bus (LMB), and Xilinx PowerPC microprocessor buses including, but not limited to, On-chip Peripheral. Bus (OPB), Processor Local Bus (PLB), Device Control Register (DCR) bus, Altera Nios II microprocessor bus including, but not limited to, Avalon Interface, and Latice LatticeMicro32 open IP microprocessor core bus including, but not limited to, Wishbone, etc.

Line-of-Sight Image Acquisition Paths 199A, 199B, 199C are electromagnetic transmission paths, which depicts light emissions from an object traveling in a straight line. The rays or waves may be diffracted, refracted, reflected, or absorbed by atmosphere and obstructions with material and generally, and cannot travel over the horizon or behind obstacles.

FIG. 2 is an illustration of an optional transponder configured for use within the present invention.

BLE XPNDER 200 is designed to be inserted into a port on cell phone 140 (as shown in FIG. 1).

BLE XPNDR 200 consists of the following components, processor 210, memory 220, radio 230, antenna 240, and port 250.

Processor 210 incorporates the functions of a central processing unit (CPU) on at least one integrated circuit. Processor 210 accepts digital data as input, processes it according to instructions stored in memory 220, and provides results as output.

Memory 220 is a physical device used to store programs (sequences of instructions) or data (e.g. program state information) on a temporary or permanent basis. Memory 220 is connected to processor 210, radio 230 and port 250.

Radio 230 is a wireless transmission device used for transmitting and receiving BLE signals via antenna 240 through free space by electromagnetic radiation of a frequency significantly below that of visible light, in the radio frequency range, from about 30 kHz to 300 GHz, which are commonly known as radio waves. Information is carried by systematically changing (modulating) some property of the radiated waves, such as, but is not limited to amplitude, frequency, phase, or pulse width. When radio waves strike an electrical conductor, the oscillating fields induce an alternating current in the conductor. The information in the radio waves can be extracted and transformed back into its original form. Alternatively to BLE, radio 230 can be configured to operate according to at least one Wireless Protocol, such as, but is not limited to, MiWi, Wi-Max, CDMA, TDMA, RFID, Satellite, etc, to achieve the goals of the present invention.

Antenna 240 is an electrical device configured to transmit/receive BLE signals. Antenna 240 converts electric power into radio waves, and vice versa. It is usually used with a radio transmitter or radio receiver. In transmission, a radio transmitter supplies an oscillating radio frequency electric current to the antenna's terminals, and the antenna radiates the energy from the current as electromagnetic waves (radio waves). In reception, an antenna intercepts some of the power of an electromagnetic wave in order to produce a tiny voltage at its terminals that is applied to a receiver to be amplified. Alternatively to BLE, antenna 240 can be configured transmit and receive signals according to at least one protocol, such as, but is not limited to, MiWi, Wi-Max, CDMA, TDMA, RFID, Satellite, etc, to achieve the goals of the present invention.

Port 250 is an electro-mechanical device for joining electrical and/or data circuits as an interface using a mechanical assembly. Only one port 250 is shown in FIG. 2 for clarity, but BLE XPNDR 200 may include additional port 250s. Port 250 can be designed to plug into a port (not shown) on cellphone 140 as illustrated in FIG. 1, in order to transmit/receive data from cellphone 140, or in conjunction with cellphone 140, for identification, authentication, permission, surveillance, or other purposes.

The location of BLE XPNDR 200 can be determined within a hybrid positioning system using a network of Wi-Fi 110A, 110B, as illustrated in FIG. 1, and/or a network of BLE WAP 130, as illustrated in FIG. 1, and/or a network of Micro Cells 151, as illustrated in FIG. 1, or by cell tower 152 ID, as illustrated in FIG. 1, and/or a network of MiWi WAP (not shown), or directly from the host cellphone 140, as illustrated in FIG. 1.

BLE XPNDER 200 is also enabled with a mag-stripe reader (not shown) that is capable of reading mag-stripe 132, as illustrated in FIG. 1.

### Practical Implementation of the Present Invention

The following example describes the present invention used in a fast-food restaurant, which includes a drive-thru.

When a vehicle drives up to an outdoor order station, a camera records the image of the license plate, to coordinate vehicle information with passenger(s)/customer(s) orders. A database and app running in the background store the license plate, and passenger(s)/customer(s) orders, in order to build a set of preferences to better serve the passenger(s)/customer(s) in the future, or offer discounts or coupons on their next visit, etc.

When a customer walks up to indoor order station, a camera records the image of the customer's face to coordinate their face with their order. A database and app running in the background store the face image, in order to build a set of preferences to better serve the customer in the future, or offer discounts or coupons on their next visit, etc.

RFID interrogators track employee badges, assets, inventory, etc. The RFID interrogators are linked to a database and app running in the background to store the electronic identification numbers associated with RFID tags. As an example, all the employee badges with RFID tags are found to be located in the restaurants cooler, or freezer, it might be deduced that a robbery is taking place. The employee badges with RFID tags can also be used to record time and attendance information related to payroll activities.

Microcells attached to a self-contained IP telephony network, sniff electronic identification numbers associated with cellphones within range. The IP telephony network is linked to a database and app running in the background to store the electronic identification numbers, in order to build a database of potential friends or foes within the operating range of the microcells. Employee electronic identification numbers associated with a cellphone can be registered with the system, in order to record time and attendance information related to payroll activities. Repeat customer's electronic identification numbers associated with a cellphone can be recorded in order to send a text message or email that includes a discount, or coupon, as a registered customer drives by, or enters the parking lot, or enters the restaurant. The IP telephony system can be used to complete calls for employees, and connect them to the Internet as a means of ensuring the employee is not making phone calls, or connecting to the Internet during designated work time.

Employee badges with magnetic strips can be used to gain access to areas secured with magnetic stripe readers, such as a freezer or cooler, or activate time clocks, or log on to computers and networks, etc.

The BLE Bluetooth Transponder can be used as a secondary form of electronic identification in conjunction with RFID, cellphones, or stand-alone to identify employees, assets, inventory etc. As an example, on a college campus, a BLE Bluetooth Transponder can be paired with a cellphone, in order to more positively identify college students, employees, professors, registered guests for various events, registered guests that are performing maintenance or construction activities, etc.

The present invention has been described in particular detail with respect to several possible embodiments. Those of skill in the art will appreciate that the invention may be practiced in other embodiments. First, the particular naming of the components and capitalization of terms is not mandatory or significant, and the mechanisms that implement the invention or its features may have different names, formats, or protocols. Also, the particular division of functionality between the various system components described herein is merely exemplary, and not mandatory; functions performed by a single system component may instead be performed by multiple components, and functions performed by multiple components may instead performed by a single component.

Unless specifically stated otherwise as apparent from the above discussion, it is appreciated that throughout the description, discussions utilizing terms such as “determining” or the like, refer to the action and processes of a computer system, or similar electronic computing device, that manipulates and transforms data represented as physical (electronic) quantities within the computer system memories or registers or other such information storage devices. Certain aspects of the present invention include process steps and instructions. It should be noted that the process steps and instructions of the present invention could be embodied in software, firmware or hardware, and when embodied in software, could be downloaded to reside on and be operated from different platforms. Furthermore, the computers referred to in the specification may include a single processor or may be architectures employing multiple processor designs for increased computing capability.

The scope of this invention should be determined by the appended claims and their legal equivalents, rather than by the examples given.

What is claimed is:

1. A security system, the security system comprising:
a plurality of LED lights with sensors operatively connected to a computer;
a facial recognition system operatively connected to the computer;
a license plate recognition system operatively connected to the computer;
an RFID system operatively connected to the computer;
a micro-cell operatively connected to an IP telephony network, which is operatively connected to the computer;
a Bluetooth wireless access point operatively connected to the computer;
a Wi-Fi wireless access point operatively connected to the computer; and
a communication system operatively connected to the computer, wherein the computer aggregates data and sends commands based on the data.
